(19) United States
(12) Patent Application Publication
(10) Pub. No.: US 2022/0019548 A1
(43) Pub. Date: Jan. 20, 2022

(54) NESTED COMMANDS FOR RADIO FREQUENCY FRONT END (RFFE) BUS

(71) Applicant: QUALCOMM Incorporated, San Diego, CA (US)

(72) Inventors: Sharon Graif, Zichron Yaakov (IL); Amit Gil, Zichron Yaakov (IL); Navdeep Mer, Bangalore (IN); Viney Kumar, Bangalore (IN)

(21) Appl. No.: 16/931,826

(22) Filed: Jul. 17, 2020

(51) Int. Cl. G06F 13/362; G06F 13/24; G06F 13/40; G06F 9/54

(52) U.S. Cl. CPC G06F 13/362; G06F 13/24; G06F 9/542; G06F 13/409; G06F 13/4068

(57) ABSTRACT

Nested commands for a radio frequency front end (RFFE) bus are provided. In particular, timing commands may be nested inside a normal data flow. On receipt of a nested timing command, a slave on the RFFE bus suspends or halts an active command and addresses the timing command. On completion of the timing command, the slave returns to the halted command. By allowing such nested commands, counters in the slave that would otherwise be used to track triggers may be eliminated or reduced and power may be conserved by placing a clock signal associated with the bus into a low power mode.

### BACKGROUND

### I. Field of the Disclosure

The technology of the disclosure relates generally to circuits having trigger events such as a wireless communication device having trigger events based on a wireless communication protocol.

### II. Background

Computing devices abound in modern society. The prevalence of these mobile communication devices is driven in part by the many functions that are now enabled on such devices. Increased processing capabilities in such devices means that mobile communication devices have evolved from pure communication tools into sophisticated mobile entertainment centers, thus enabling enhanced user experiences.

Most such mobile communication devices have a suite of circuits coupled to one another by a bus to serve as a radio front end. The MIPI® Alliance has promulgated a standard to make devices associated with such radio front ends compatible. This standard is descriptively named the Radio Frequency Front End Control Interface (RFFE). The standard was initially released in July 2010 as v.1.00.00. Subsequently, RFFE has been updated to accommodate 5G communication requirements. In particular, RFFE 3.0 has introduced the concept of a Timed-Trigger that permits reduction in control latency, but necessitates tracking multiple trigger events in RFFE slave devices. Typically, such trigger tracking demands multiple counters.

### SUMMARY OF THE DISCLOSURE

Aspects disclosed in the detailed description include nested commands for a radio frequency front end (RFFE) bus. In particular, timing commands may be nested inside a normal data flow. On receipt of a nested timing command, a slave on the RFFE bus suspends or halts an active command and addresses the nested timing command. On completion of the nested timing command, the slave returns to the halted command. By allowing such nested commands, counters in the slave that would otherwise be used to track triggers may be eliminated or reduced, and power may be conserved by placing a clock signal associated with the bus into a low-power mode.

In this regard in one aspect, a circuit is disclosed. The circuit includes a bus interface coupled to a two-wire bus. The circuit also includes a counter circuit. The circuit also includes a control circuit coupled to the bus interface. The control circuit is configured to generate a trigger command responsive to a count within the counter circuit expiring. The control circuit is also configured to send the trigger command to a slave through the bus interface as a nested command.

In another aspect, a circuit is disclosed. The circuit includes a bus interface coupled to a two-wire bus. The circuit also includes a control circuit coupled to the bus interface. The control circuit is configured to detect a nested command within an active data stream, the nested command sent by a master through the two-wire bus. The control circuit is also configured to halt an active process responsive to receipt of the nested command. The control circuit is also configured to execute the nested command after halting the active process.

In another aspect, an RFFE system is disclosed. The RFFE system includes a two-wire bus including a clock line and a data line. The RFFE system also includes a master circuit. The master circuit includes a bus interface coupled to the two-wire bus. The master circuit also includes a control circuit. The control circuit is configured to send a command to a slave circuit over the data line of the two-wire bus. The control circuit is also configured to determine that the slave circuit needs a trigger. The control circuit is also configured to nest a trigger command in the command to the slave circuit. The RFFE system also includes the slave circuit. The slave circuit includes a slave bus interface coupled to the two-wire bus. The slave circuit also includes a slave control circuit. The slave control circuit is configured to detect the command. The slave control circuit is also configured to activate a process responsive to the command. The slave control circuit is also configured to detect the trigger command nested in the command. The slave control circuit is also configured to, responsive to the trigger command, halt the process. The slave control circuit is also configured to activate the trigger according to the trigger command.

In another aspect, a method for controlling an RFFE bus is disclosed. The method includes initiating a command from a master to a slave across the RFFE bus. The method also includes, while a data line of the RFFE bus is active, sending a nested command to the slave. The method also includes halting at the slave an active process responsive to the nested command. The method also includes acting on the nested command.

### BRIEF DESCRIPTION OF THE FIGURES

FIG. 1 is a block diagram of an exemplary wireless communication device having a radio frequency front end (RFFE) system with an RFFE bus;

FIG. 2 is a block diagram of an RFFE slave that may be associated with the RFFE bus of FIG. 1;

FIG. 3A is a simplified block diagram of a conventional RFFE slave having a single counter for a given triggered circuit;

FIG. 3B is a simplified block diagram of a conventional RFFE slave having multiple triggered elements, each having a dedicated counter and detector;

FIG. 4 is a block diagram of an RFFE system having a master and two slaves able to use nested commands according to an exemplary aspect of the present disclosure;

FIG. 5 is a flowchart illustrating an exemplary process for sending and using nested commands according to an exemplary aspect of the present disclosure;

FIG. 6A is a representation of an exemplary write command frame on an RFFE bus with a parity bit that can be used to signal a nested command highlighted;

FIG. 6B is a representation of an exemplary data frame on an RFFE bus with the parity bit that can be used to signal a nested command highlighted;

FIG. 6C is a representation of how the parity bit may be modified to signal a nested command if the parity bit is one (1);

FIG. 6D is a representation of how the parity bit may be modified to signal a nested command if the parity bit is zero (0);

FIG. 6E is a representation of behavior of clock and data lines when a nested command is sent and ended according to an exemplary aspect of the present disclosure; and

FIG. 7 is a signal flow diagram showing how a master initiates a halt to a slave using a nested command.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include nested commands for a radio frequency front end (RFFE) bus. In particular, timing commands may be nested inside a normal data flow. On receipt of a nested timing command, a slave on the RFFE bus suspends or halts an active command and addresses the nested timing command. On completion of the nested timing command, the slave returns to the halted command. By allowing such nested commands, counters in the slave that would otherwise be used to track triggers may be eliminated or reduced and power may be conserved by placing a clock signal associated with the bus into a low-power mode.

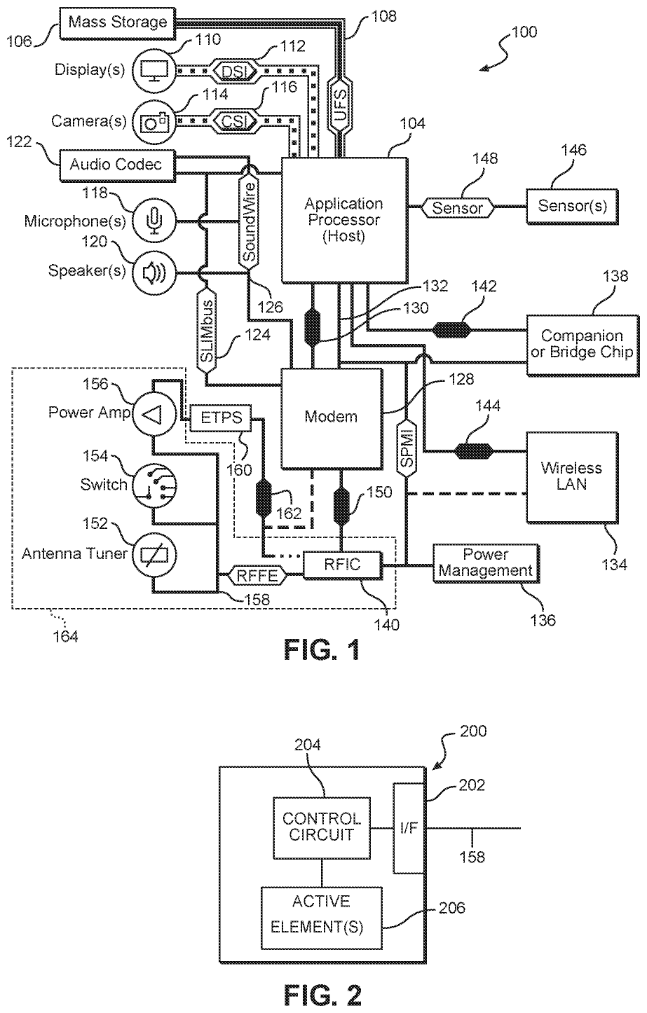

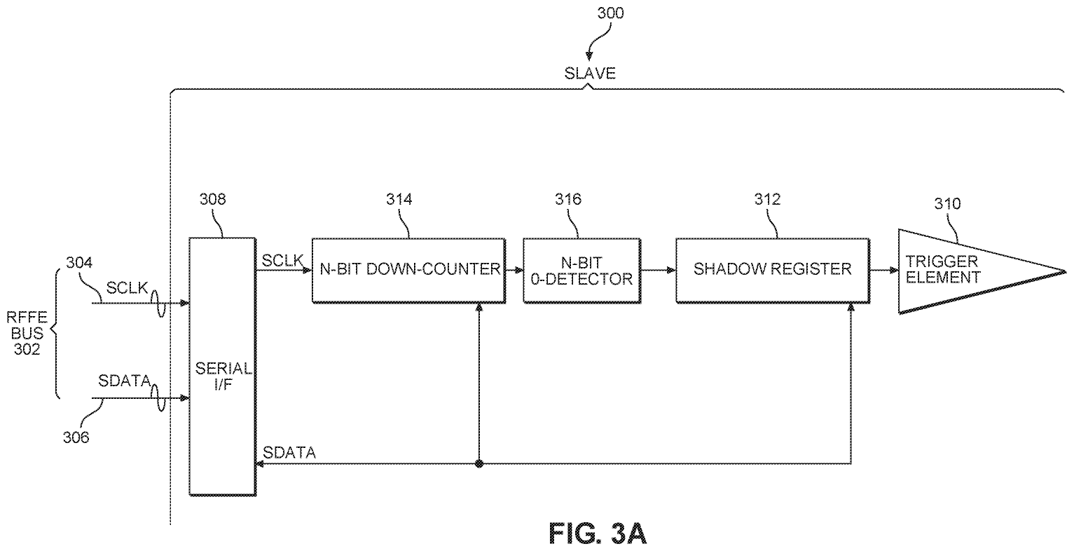

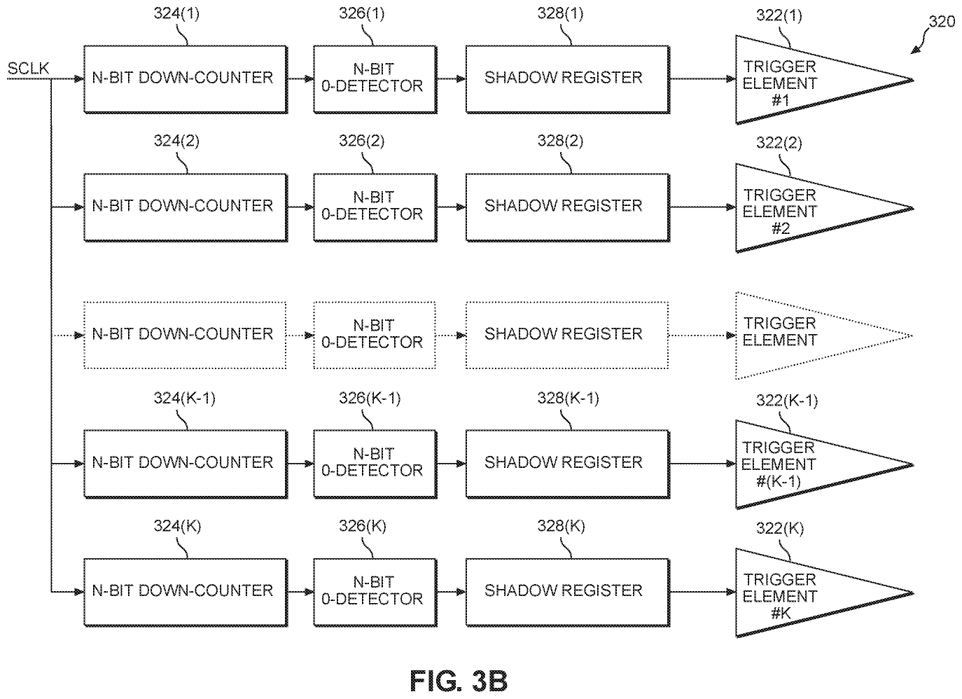

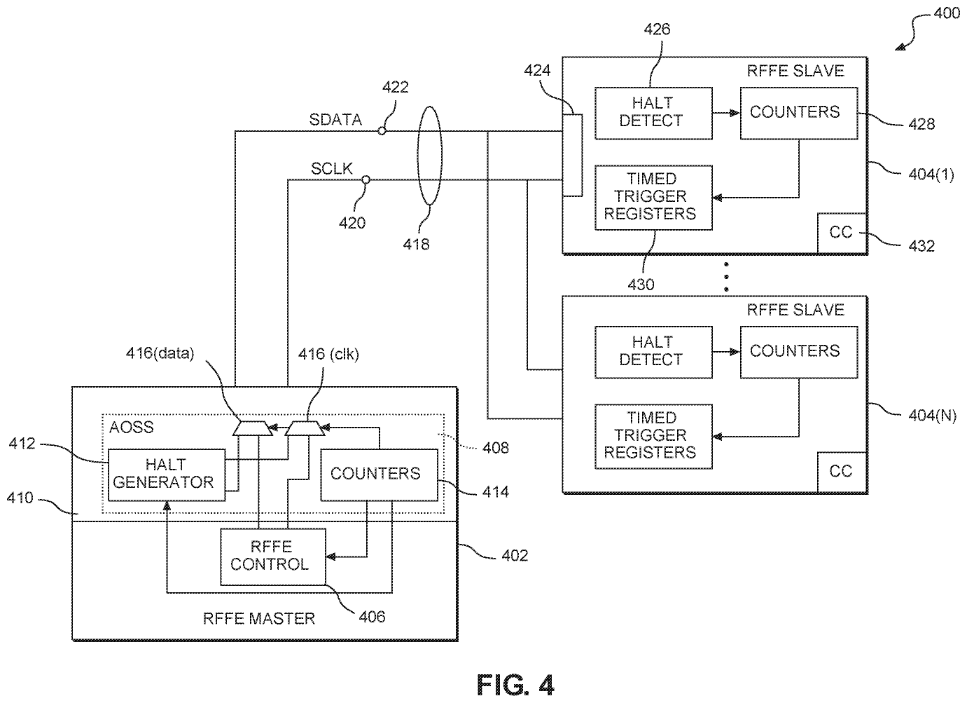

To understand the context of the present disclosure, an overview of a computing device that includes an RFFE system including an RFFE bus is provided in FIG. 1, with more detailed descriptions of slaves on the RFFE bus described in FIGS. 2-3B. A description of an RFFE system that may use the nested commands of the present disclosure begins below with reference to FIG. 4.

In this regard, FIG. 1 is a system-level block diagram of an exemplary computing device and in particular a mobile terminal 100 such as a smart phone, mobile computing device, tablet, or the like. The mobile terminal 100 includes an application processor 104 (sometimes referred to as a host) that communicates with a mass storage element 106 through a universal flash storage (UFS) bus 108. The application processor 104 may further be connected to a display 110 through a display serial interface (DSI) bus 112 and a camera 114 through a camera serial interface (CSI) bus 116. Various audio elements such as a microphone 118, a speaker 120, and an audio codec 122 may be coupled to the application processor 104 through a serial low-power interchip multimedia bus (SLIMbus) 124. Additionally, the audio elements may communicate with each other through a SOUNDWIRE bus 126. A modem 128 may also be coupled to the SLIMbus 124 and/or the SOUNDW IRE bus 126. The modem 128 may further be connected to the application processor 104 through a peripheral component interconnect (PCI) or PCI express (PCIe) bus 130 and/or a system power management interface (SPMI) bus 132.

With continued reference to FIG. 1, the SPMI bus 132 may also be coupled to a wireless local area network (LAN or WLAN) integrated circuit (IC) (LAN IC or WLAN IC) 134, a power management integrated circuit (PMIC) 136, a companion IC (sometimes referred to as a bridge chip) 138, and a radio frequency IC (RFIC) 140. It should be appreciated that separate PCI buses 142 and 144 may also couple the application processor 104 to the companion IC 138 and the WLAN IC 134. The application processor 104 may further be connected to sensors 146 through a sensor bus 148. The modem 128 and the RFIC 140 may communicate using a bus 150.

With continued reference to FIG. 1, the RFIC 140 may couple to one or more RFFE elements, such as an antenna tuner 152, a switch 154, and a power amplifier 156 through an RFFE bus 158. Additionally, the RFIC 140 may couple to an envelope tracking power supply (ETPS) 160 through a bus 162, and the ETPS 160 may communicate with the power amplifier 156. Collectively, the RFFE elements, including the RFIC 140, may be considered an RFFE system 164. It should be appreciated that the RFFE bus 158 is a two-wire bus and may be formed from a clock line and a data line (not illustrated).

It should be appreciated that typically the RFIC 140 is considered the master or host of the RFFE system 164 and particularly the master of the RFFE bus 158. In contrast, the antenna tuner 152, the switch 154, and the power amplifier 156 are typically considered to be slaves for the RFFE system 164 and the RFFE bus 158.

A generic RFFE slave 200, sometimes referred to as a slave circuit, is illustrated in FIG. 2. In particular, the RFFE slave 200 includes a bus interface (sometimes referred to as I/F) 202 that is configured to couple to the RFFE bus 158 or other comparable two-wire bus. The bus interface 202 is controlled by a control circuit 204, which may also control one or more active elements 206 (only one shown). The control circuit 204 may sometimes be referred to as a slave control circuit.

By way of example, the RFFE slave 200 may be the power amplifier 156, and the active elements 206 may be individual low noise amplifiers (LNAs) for different frequency bands. The active elements 206 may need to be triggered at certain times depending on which frequencies are being used to effectuate wireless communications (e.g., to or from a remote base station). In view of this need to activate or trigger the active elements 206, they are also referred to as triggered elements. The RFFE 3.0 standard introduces the concept of immediate triggers, which cause the trigger element to act immediately on receipt of the trigger command, and timed triggers, which trigger triggered elements at specific subsequent times. It should further be appreciated that while the term “triggered elements” is used, an actual active element 206 is in reality a circuit within an IC or chip that is the RFFE slave 200. While exemplary aspects of the RFFE slave 200 may include new circuit structures within the control circuit 204, the actual active elements 206 are generally conventional and well understood.

Conventional systems provide individual counters and registers for each active element to track timed trigger events. To assist in understanding this conventional system, FIG. 3A illustrates a slave 300 coupled to an RFFE bus 302. The RFFE bus 302 is further coupled to a host or master (not shown) and includes a clock line 304 and a data line 306. The clock line 304 carries a clock signal SCLK thereon, and the data line 306 carries a data signal SDATA thereon. The slave 300 is coupled to the RFFE bus 302 through a serial I/F 308. The slave 300 further includes a trigger element 310, which for the sake of example, may be an LNA. The trigger element 310 needs to be triggered at a precise time to amplify a signal that is being manipulated (e.g., transmitted or received) by an RFFE system (not shown). The host (still not shown) sends instructions and a timing value in the SDATA signal over the data line 306. The instructions are loaded into a shadow register 312, and the timing value is loaded into an N-bit down-counter 314. The SCLK signal causes the N-bit down-counter 314 to decrement down from the timing value loaded therein from the SDATA signal. An N-bit 0-detector 316 detects when the N-bit down-counter 314 has been decremented down to zero (0) and, when 0 is reached, causes the contents of the shadow register 312 to be loaded into the trigger element 310. Equivalently, the N-bit down-counter 314 may be replaced with an up-counter that counts to a predefined threshold before loading the contents of the shadow register 312 to the trigger element 310.

Similarly, FIG. 3B illustrates a slave 320 that has multiple trigger elements 322(1)-322(K). For each of the multiple trigger elements 322(1)-322(K), there is a corresponding N-bit down-counter 324(1)-324(K), an N-bit 0-detector 326(1)-326(K), and a shadow register 328(1)-328(K). Again, the contents of the shadow registers 328(1)-328(K) are loaded from data in the SDATA signal (not shown in FIG. 3B) as are values for the N-bit down-counters 324(1)-324(K). Each N-bit down-counter 324(1)-324(K) is decremented by the SCLK signal. When a zero is detected by the corresponding one of the N-bit 0-detectors 326(1)-326(K), the contents of the corresponding shadow register 328(1)-328(K) are loaded into the respective trigger element 322(1)-322(K). Again, the trigger elements 322(1)-322(K) may be, for example, LNAs, each operating at different frequencies which are turned on to certain amplifications at different times.

The presence of the plural N-bit down-counters 324(1)-324(K), one for each trigger element 322(1)-322(K) consumes relatively large amounts of space within an IC. Likewise, each N-bit down-counter 324(1)-324(K) requires an active clock signal from the master, which consumes power which, in turn, may negatively impact time between recharging a battery associated with a mobile terminal.

Exemplary aspects of the present disclosure remove most of the counters from the slaves and keep track of trigger events using counters at the master. Then when the master detects an upcoming trigger event, the master may send an immediate trigger command as a nested command to the slave. The slave halts any active processes based on the arrival of the nested command, executes the immediate trigger command, and then resumes the halted process. Reduction of the number of counters at the slave reduces the size of the IC associated with the slave and reduces or eliminates the need for a clock signal to be maintained on the RFFE bus. Accordingly, the RFFE bus may enter a sleep mode to conserve power.

In this regard, FIG. 4 illustrates an RFFE system 400 with circuitry that allows a master 402 (sometimes referred to as master circuit) to send a nested command to a slave 404(1)-404(N) that causes the slave 404(1)-404(N) to halt an active process and execute a trigger within the nested command. After execution of the trigger, the slave 404(1)-404(N) may resume the halted process. To effectuate these nested commands, the master 402 may include a control circuit 406 that is coupled to an always on subsystem (AOSS) 408 that is part of a bus interface 410, which is more specifically an RFFE bus interface and sometimes referred to as a master bus interface. The AOSS 408 may include a halt generator circuit 412, a plurality of counters 414, and multiplexers 416(clk) and 416(data). The bus interface 410 is configured to be coupled to an RFFE bus 418 formed from a clock line (SCLK) 420 and a data line (SDATA) 422. The multiplexers 416(clk) and 416(data) are coupled to the clock line 420 and the data line 422, respectively.

With continued reference to FIG. 4, a given slave 404 such as slave 404(1) has a slave bus interface 424 configured to be coupled to the RFFE bus 418. The slave 404 may further have a halt detect circuit 426, counters 428, and timed trigger registers 430. In some exemplary aspects, the counters 428 and timed trigger registers 430 may be omitted. However, if the counters 428 and timed trigger registers 430 are included, they may be smaller than counters and registers used in conventional RFFE slaves, because the counters 428 and timed trigger registers 430 may only need to be three to four cycles instead of the traditional ten to forty cycles under RFFE 3.0. Additionally, the slave 404 may include a control circuit 432.

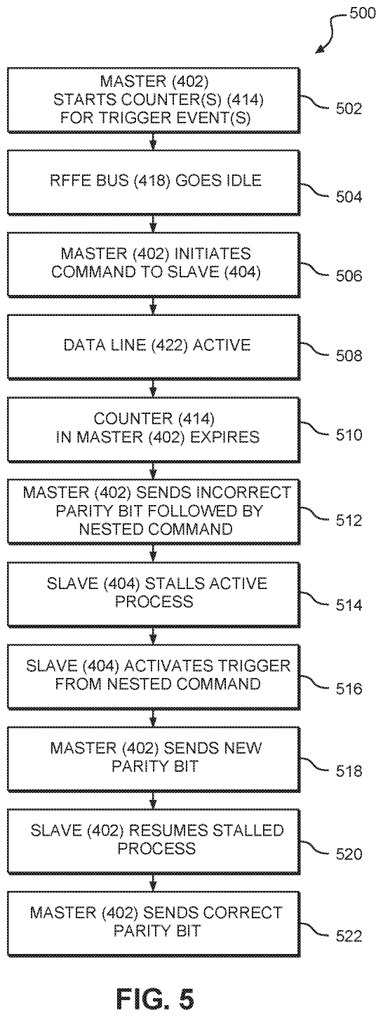

In use, the master 402 controls the RFFE bus 418. Commands are sent to a given slave 404 to cause the slave 404 to operate in a particular fashion (e.g., change frequency at a particular time, change power levels, or the like). Because the slaves 404(1)-404(N) may have limited (or no) counters 428 for use for timed triggers, the master 402 may track triggers using the counters 414. When a counter 414 expires by reaching zero (if a count-down counter) or by reaching a threshold (if a count-up counter), the master 402 may need to send an immediate trigger command to a slave 404(1)-404(N) while an active process is ongoing. To effectuate such an immediate command, the halt generator circuit 412 may receive a signal from the counter 414 that has expired and inject a nested command onto the data line 422 of the RFFE bus 418 in the midst of the active command on the data line 422. This process is set forth with greater detail in FIG. 5.

In this regard, FIG. 5 provides a flowchart of a process 500 associated with sending a nested command to a slave 404 over the RFFE bus 418. Specifically, the master 402 may start a counter or counters 414 for trigger events (block 502). At some point, while the counters 414 are still counting, the RFFE bus 418 may go idle (block 504). Note that this idle state for the RFFE bus 418 is optional and depends on the activity of the computing device in which the RFFE system 400 resides. The master 402 may then initiate a command to a slave 404 (block 506) and the data line 422 is active (block 508).

While the data line 422 is active, a counter 414 in the master 402 expires (block 510). Note this counter 414 may have started counting before the current active command (e.g., at bock 502) or during the active command (not shown). The halt generator circuit 412 may activate and prepare a nested command. In an exemplary aspect, the master 402 sends an incorrect parity bit in the midst of the active data flow, followed by a nested command (block 512). On receiving the incorrect parity bit as detected by the halt detect circuit 426, the slave 404 may stall an active process (block 514) and read the nested command. The slave 404 may then activate the trigger from the nested command (block 516).

At the end of the nested command, the master 402 sends a new parity bit (block 518) that is correct to show the end of the nested command. The slave 404 then resumes the stalled process (block 520). At the end of the active data flow, the master 402 sends a final parity bit that is correct (block 522).

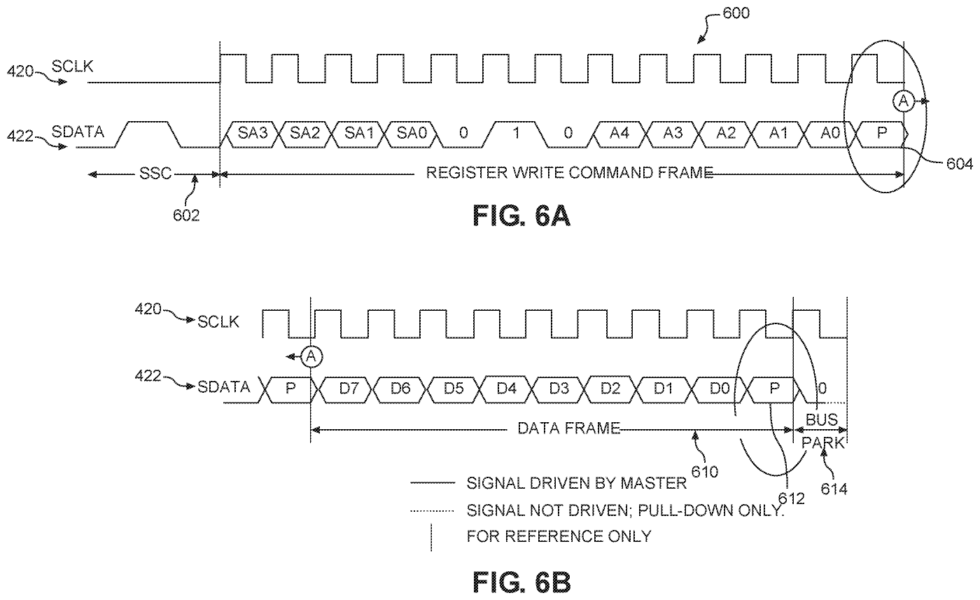

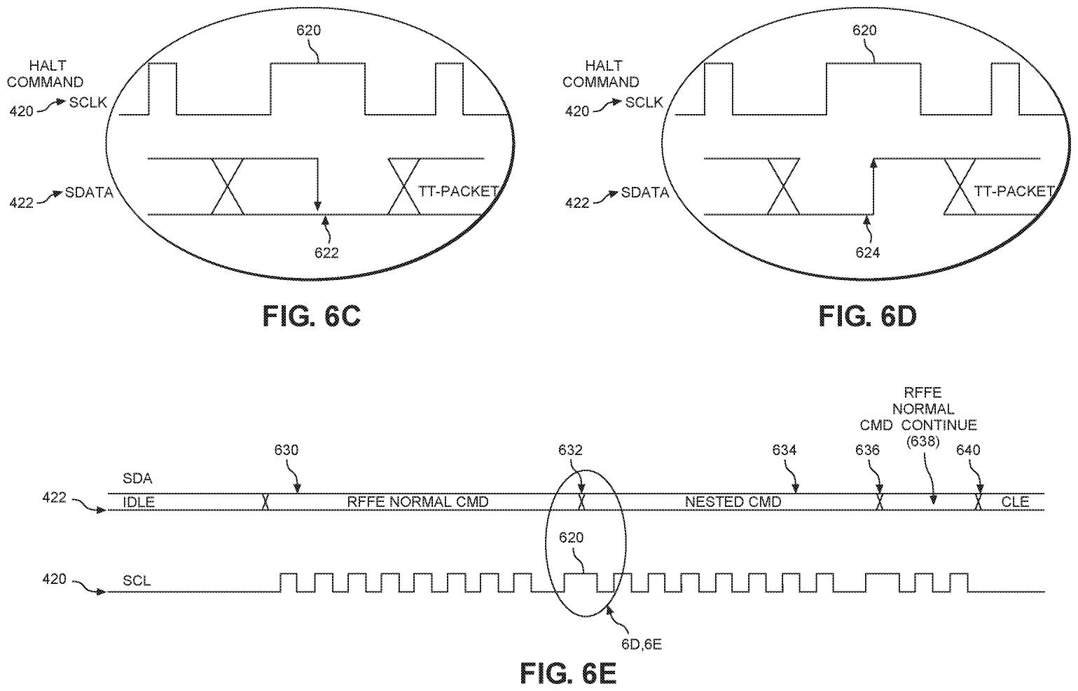

FIGS. 6A-6E show example signals on the clock line 420 and data line 422 that illustrate how a nested command may be sent from a master 402 to a slave 404. In particular, FIG. 6A shows a register write command frame 600 send from a master 402 to a slave 404 according to the RFFE standard. Before the register write command frame 600, a start sequence command (SSC) 602 may occur on the data line 422. Note that during the SSC 602, the clock line 420 is idle or at a logical low. At the end of the register write command frame 600, the master 402 sends a parity bit 604 (also denoted P in FIG. 6A). Similarly, FIG. 6B shows a data frame 610 on the data line 422. As with the register write command frame 600, the data frame 610 ends with a parity bit 612, which may be followed by the bus 418 being parked 614.

Exemplary aspects of the present disclosure send an incorrect parity bit at parity bit 604 or parity bit 612 to signal to the slave 404 that there is a nested command following. While other locations in either frame 600 or frame 610 may be used, such other locations may require more bits (which may introduce unwanted latency) or require more sophisticated detection hardware. In addition to the change in the parity bit, the period of a concurrent clock cycle may be extended to double that of adjacent clock cycles. Such exemplary aspects are illustrated in FIGS. 6C and 6D. In particular, in FIG. 6C, an expanded clock cycle 620 is present on the clock line 420 while a dropping parity bit 622 of 1 is illustrated on the data line 422. FIG. 6D illustrates the expanded clock cycle 620 with a rising parity bit 624 of 0 on the data line 422.

FIG. 6E illustrates more comprehensively a data stream 630 on the data line 422, interrupted by an incorrect parity bit 632 at the expanded clock cycle 620 followed by a nested command 634. The nested command 634 ends with a parity bit 636. An interrupted command 638 follows ending with a final correct parity bit 640.

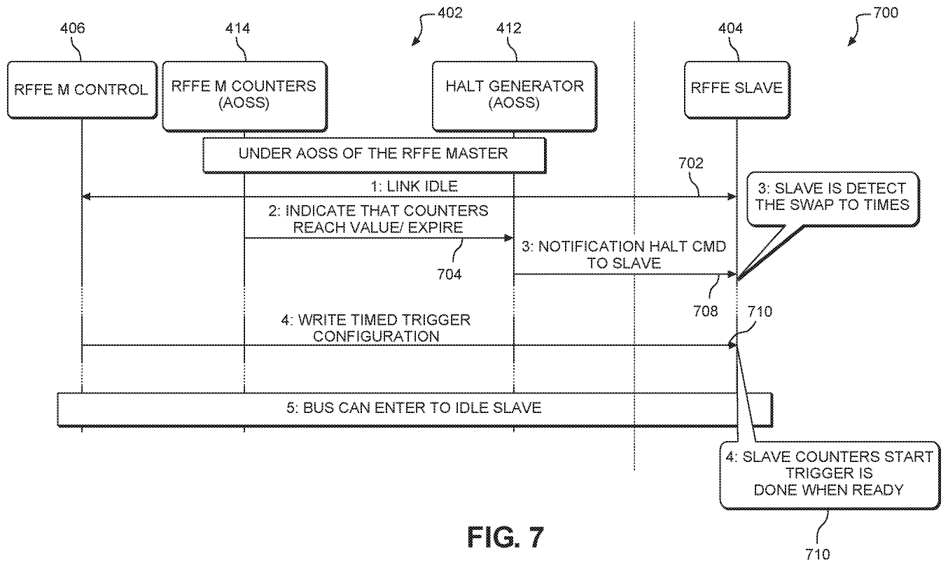

A different perspective is provided in FIG. 7 which shows the signal flows in a more abstract fashion than FIGS. 6A-6E. In particular, a signal flow 700 begins with the RFFE bus 418 idle (line 702). The counters 414 indicate to the halt generator circuit 412 that the counters 414 have expired or reached a threshold value (line 704), which causes the halt generator circuit 412 to send a halt command (i.e., the nested command) to the slave 404 (line 706). The control circuit 406 writes the trigger configuration to the timed trigger register 430 (line 708) after which the RFFE bus 418 may return to idle (line 710).

The nested commands for an RFFE bus according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The devices described herein may be employed in any circuit, hardware component, IC, or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

1. A circuit comprising:
a bus interface coupled to a two-wire bus;
a counter circuit; and
a control circuit coupled to the bus interface and configured to:
generate a trigger command responsive to a count within the counter circuit expiring, wherein the trigger command is configured to cause a triggered element to act; and
send the trigger command to a slave through the bus interface as a nested command.

2. The circuit of claim 1, wherein the bus interface is coupled to a radio frequency front end (RFFE) bus.

3. The circuit of claim 1, wherein the counter circuit comprises a count down circuit.

4. The circuit of claim 1 integrated into a modem.

5. The circuit of claim 1, further comprising a halt generator circuit used by the control circuit to form the nested command.

6. The circuit of claim 1, wherein the control circuit is configured to signal the nested command by changing a parity bit in a data signal on the two-wire bus.

7. The circuit of claim 1 integrated into an integrated circuit (IC).

8. The circuit of claim 1 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

9. A circuit comprising:
a triggered element;
a bus interface coupled to a two-wire bus; and
a control circuit coupled to the bus interface and configured to:
detect a nested command within an active data stream, the nested command sent by a master through the two-wire bus, wherein the nested command comprises a trigger command configured to cause the triggered element to act;
halt an active process responsive to receipt of the nested command; and
execute the nested command after halting the active process.

10. The circuit of claim 9, wherein the bus interface comprises a radio frequency front end (RFFE) bus interface.

11. The circuit of claim 9, wherein the control circuit is further configured to resume the active process after completion of the nested command.

12. The circuit of claim 9, wherein the control circuit is configured to detect the nested command by evaluating an incorrect parity bit.

13. The circuit of claim 9 integrated into one of a power amplifier, a switch, or an antenna tuner.

14. The circuit of claim 9, wherein the control circuit is configured to operate as a slave on the two-wire bus.

15. The circuit of claim 9 integrated into an integrated circuit (IC).

16. The circuit of claim 9 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

17. A radio frequency front end (RFFE) system, comprising:
a two-wire bus comprising a clock line and a data line;
a master circuit comprising:
a bus interface coupled to the two-wire bus; and
a control circuit configured to:
send a command to a slave circuit over the data line of the two-wire bus;
determine that the slave circuit needs a trigger; and
nest a trigger command in the command to the slave circuit; and
the slave circuit comprising:
a slave bus interface coupled to the two-wire bus; and
a slave control circuit configured to:
detect the command;
activate a process responsive to the command;
detect the trigger command nested in the command;
responsive to the trigger command, halt the process; and
activate the trigger according to the trigger command.

18. The RFFE system of claim 17, wherein the slave control circuit is further configured to resume the process after completion of the trigger.

19. The RFFE system of claim 17, wherein the control circuit is configured to indicate the nested trigger command by changing a parity bit.

20. The RFFE system of claim 19, wherein the parity bit occurs at a clock cycle having a period twice that of neighboring clock cycles.

21. The RFFE system of claim 17, wherein the master circuit comprises a modem.

22. The RFFE system of claim 17, wherein the slave circuit comprises one of an antenna tuner, a switch, or a power amplifier.

23. A method for controlling a radio frequency front end (RFFE) bus, the method comprising:
initiating a command from a master to a slave across the RFFE bus;
while a data line of the RFFE bus is active, sending a nested command comprising a trigger command to the slave;
halting at the slave an active process responsive to the nested command; and
causing a triggered element to act based on the trigger command.

24. The method of claim 23, wherein sending the nested command comprises changing a parity bit associated with the nested command.

25. The method of claim 23, further comprising, after finishing the nested command, resuming the active process.

26. The method of claim 24, further comprising sending a correct parity bit to signify an end of the nested command.

27. (canceled)

28. The method of claim 23, further comprising using a counter to determine an event needing the trigger command.
